(19) United States
(12) Patent Application Publication
(10) Pub. No.: US 2012/0210616 A1
(43) Pub. Date: Aug. 23, 2012

(54) Commu-rider

(76) Inventor: Serge Leonce Laraque, Mentone, CA (US)

(21) Appl. No.: 12/925,950

(22) Filed: Jan. 11, 2010

(51) Int. Cl. G09F 21/04; A47G 1/17; A47G 1/06

(52) U.S. Cl. 40/591; 40/765; 40/745

(57) ABSTRACT

The device is comprised of a frame with a compartment and a sliding channel allowing for inserting and removing specialty messages with minimum effort. Its innovative aspect allows one to display or rotate black and white or multicolor human or computer generated text, graphics, and images.

By means of suction cups, the device can be attached to any smooth surface, including vehicle side and rear windows, and windshield. The device also attaches to glass and window panels of commercial establishments adding to their marketing and advertising opportunities and displays.

### BACKGROUND OF THE INVENTION

The present invention, Commu-Rider relates to a signage system designed to allow motorists and store keepers—to display computer generated signs, graphics or messages. Computer generated text and graphics are then inserted into a fabricated or molded plastic apparatus with an internal sliding system, which is secured to the rear windshield, side window of a vehicle or the front glass plate of a business establishment. The device is attached to any material, glass, steel, or plastic by means of three (3) suction cups. The said invention makes it possible—for motorists or store keepers to put on view interchangeable messages, using human or computer generated text, images or drawings.

### BRIEF SUMMARY OF THE INVENTION

In one embodiment, the present invention is a rectangular device made of plastic material with rounded corners with an internal card sliding system for the positioning of the completed graphics. Since the invention will be displayed in places susceptible to sun exposure, such material will be protected with a U V (Ultra Violet) coating to prevent fading.

The (Commu-Rider) is designed to accept a card stock—paper to be—inserted—into the sliding system between two parallel walls, allowing quick messages interchangeability when deemed necessary. The rectangular shape of the device is—approximately 14 inches—long by 6.5 inches—high with a depth of ⅜ of an inch with a viewable message window of 12 inches by 4.5 inch. The Commu-Rider can be mounted on any smooth surface, anywhere. The three (3) suction cups are internally fasten with three (3) studs and nuts positioned inside the rear frame holding the apparatus together. The suctions cups assembly prevents the two frames from uncoupling when attached to a surface.

The present invention provides its benefits to a broad spectrum of applications. While the description which follows hereinafter is meant to be representative of a number of applications, it is however, not exhaustive. Its uniqueness allows anyone to post messages inside the rear windshield , side windows of a vehicle or the facade—of their business establishment with minimum effort , thus, reaping the cost savings of replacing expansive, faded—and—outdated one time used window graphics . The device opens the way to unlimited arrays of adaptations and uses. Briefly described, the invention is a mobile, as well as a fixed signage system

### BRIEF DESCRIPTION OF THE DRAWINGS

Referring to the drawings for the purpose of illustration and not limitation.

FIG. 1 Is a front elevation view of the main frame and the message center #1 Frame #2 Suction Cups #3 Message Center

FIG. 2 Is a top view of the frame with the 3 suction cups #1 Frame #2 Suction Cups

FIG. 3 Is a side view of the frame. #1 Front and rear frame #2 Suction Cups #3 Opening for message center card.

FIG. 4 Is detached view of the frame showing the suction cups and the internal sliding system. #1 Frame Front #2 Suction Cups Top and Bottom #3 Rear Frame

FIG. 5 Perspective. Is a perspective angled of the completed apparatus. #1 Frame #2 Suction Cups #3 Sliding card opening

FIG. 6 A Rear elevation of the completed apparatus. #1 Front frame #2 Suction Cups #3 Rear frame

FIG. 7 Perspective. A detached rear perspective view of the device showing the finger grabbing slot and the card sliding system. The grabbing slot is for quick insert and removal of messages. #1 Frame #2 Suction Cups top and bottom #3 Rear frame

FIG. 8 Rear elevation with finger grabbing slot. #1 Frame #2 Suction cups #3 Rear panel

FIG. 9. Front view elevation showing rear finger grabbing slot. #1 Frame #2 Suction cups #3 Rear panel

FIG. 10 Assembly of suction and frame and sliding compartment. #1 Frame #2 Suction cups #3 Rear panel connected with front panel

FIG. 11 Enlarged detail of suction cup connection #1 Suction cup #2 Suction connection to frame

### DETAIL DESCRIPTION OF THE INVENTION

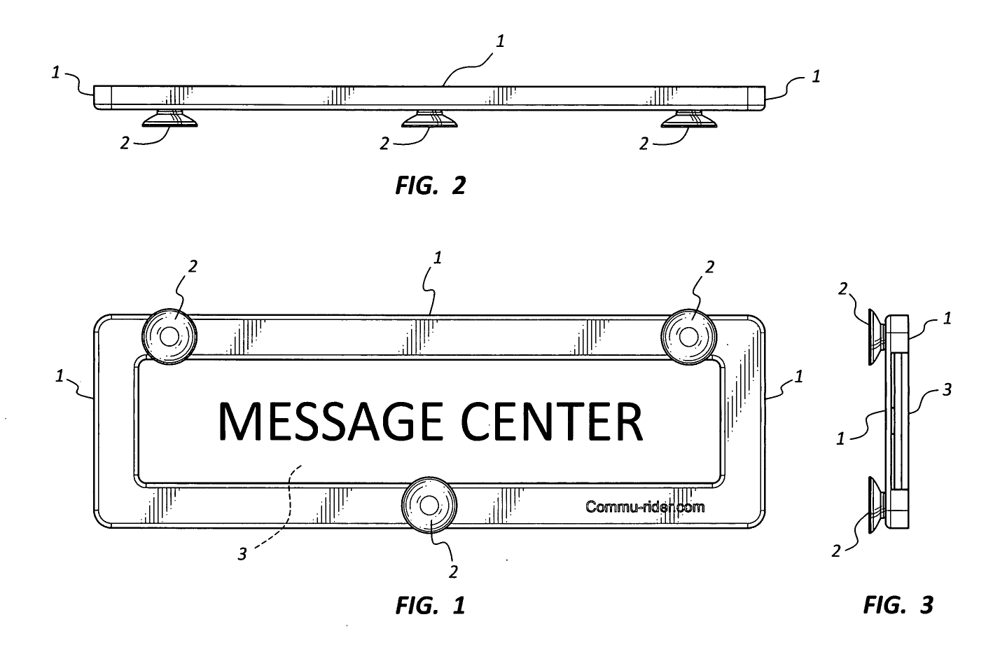

FIG. 1. The Commu-Rider device of the invention comprises of a plastic frame with a sliding signage system. Main frame #1, (size 14.00 in×6.50 in). #2 (2) Suction cups on top (1) at the bottom of frame: total three (3). #3 The message center (size 12.00 in×4.5 in)

FIG. 2.

Is a top view of the main frame #1. #2 is the three (3) suction cups. Two (2) at the top and one (1) at the bottom of the frame.

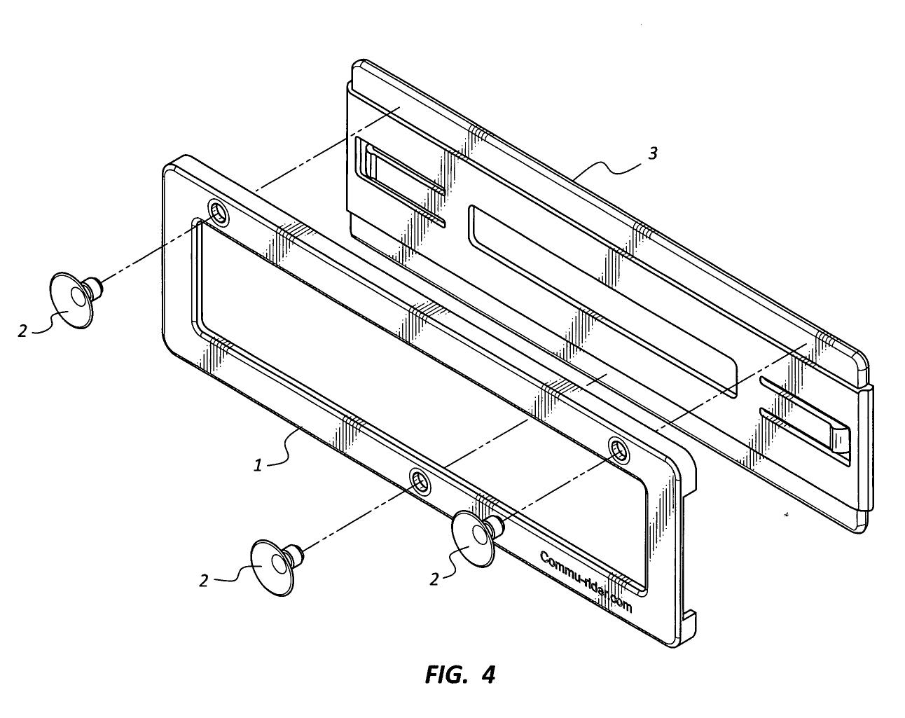

FIG. 3.

Illustrates a side elevation of the main frame. #1 and #2 are the suction cups and studs. #3 shows the opening for sliding messages.

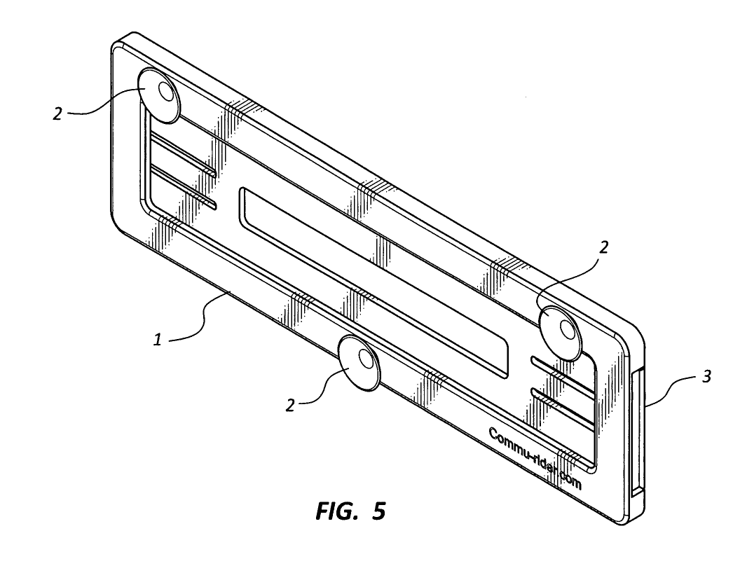

FIG. 4 Perspective. Is a perspective view of the detached frame showing the connection between the suction cups and the threaded nuts connecting both panels.

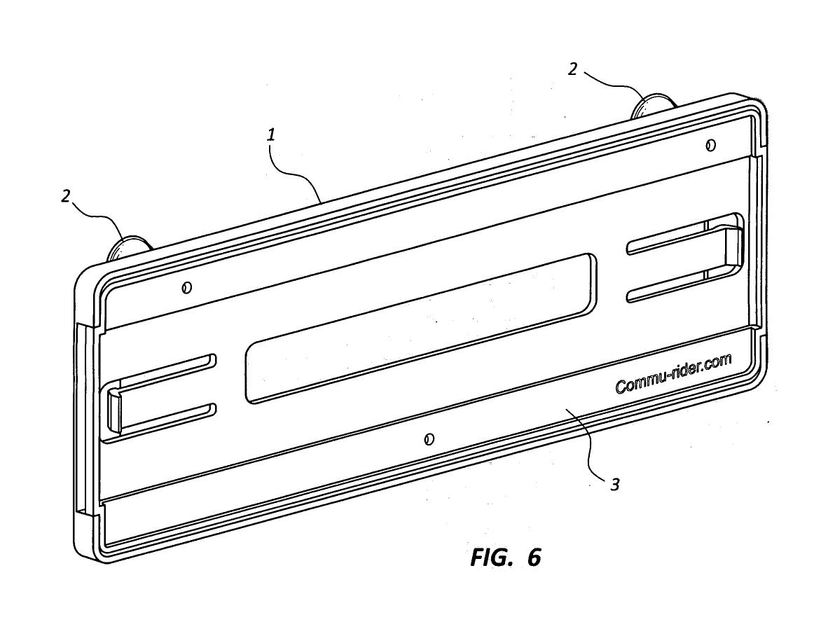

FIG. 5. Perspective. Is a transparent view of the completed apparatus showing the finger grabbing slot in the background.

FIG. 6. Perspective. A rear view of the completed device, showing the finger grabbing system for quick signage removal.

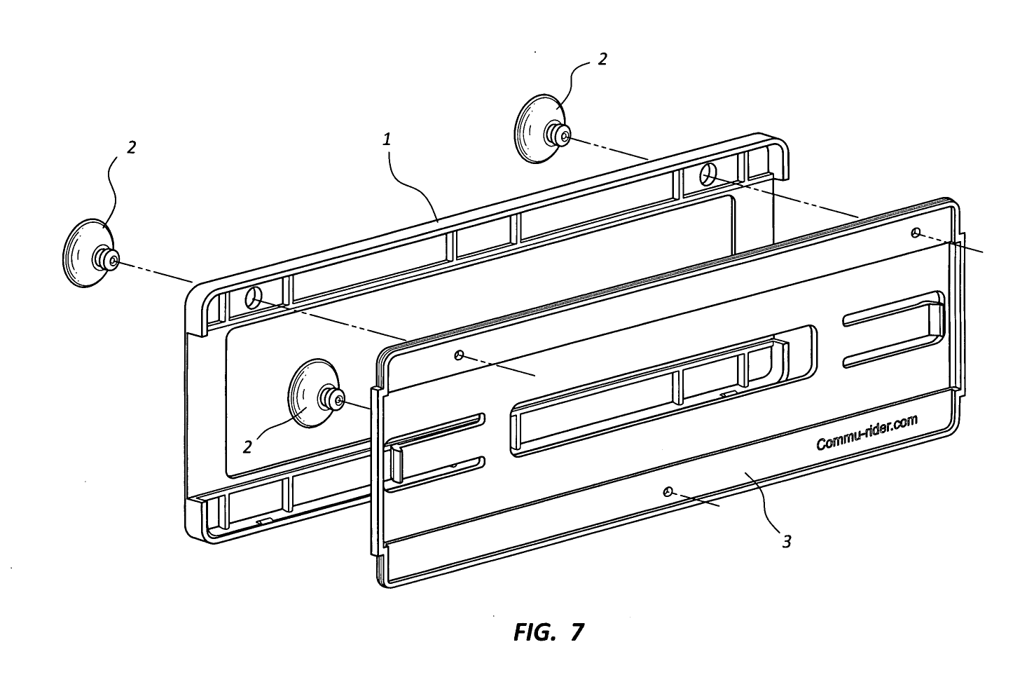

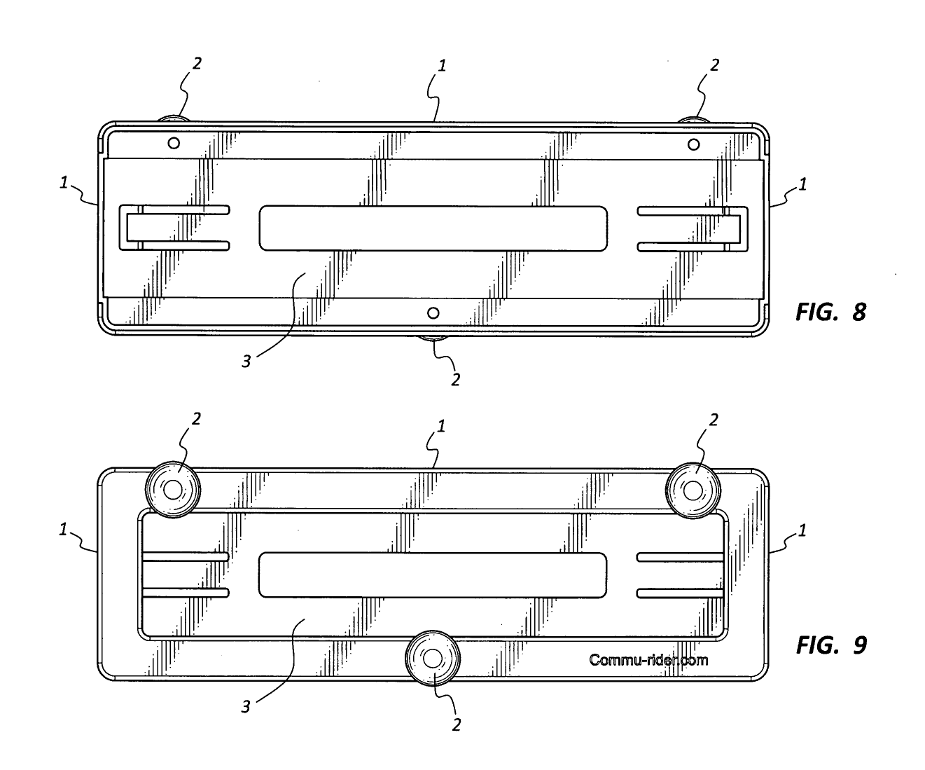

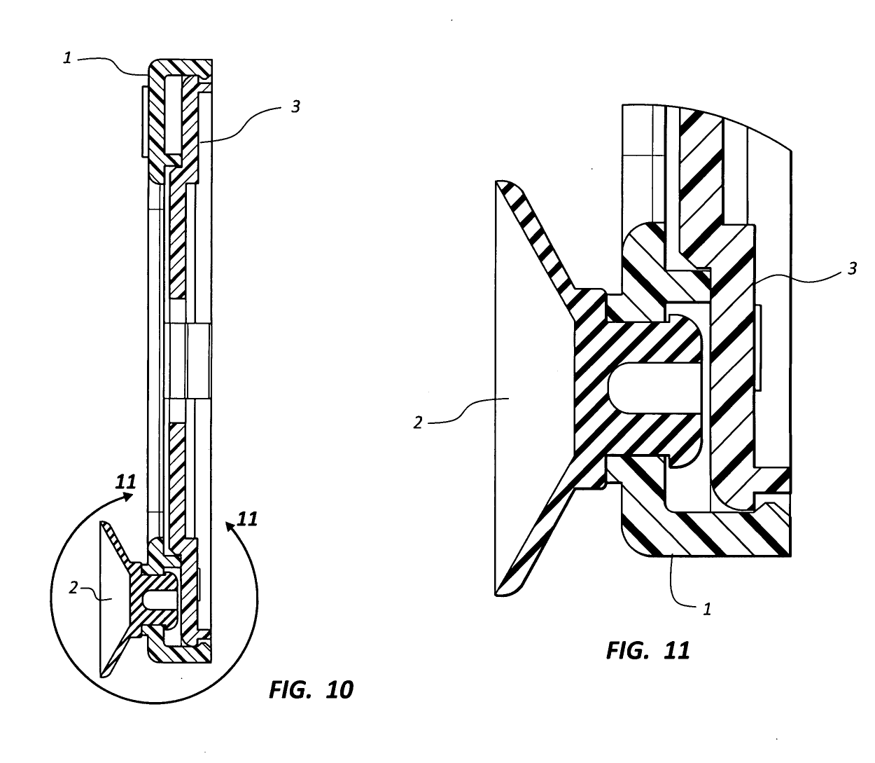

FIG. 7. Perspective. Is a rear view showing the detached frames. (1) Front panel (2) The suction cup top and bottom (3) Rear panel showing finger grabbing slot on the back.

What is claimed:

1. A rectangular frame with an internal sliding system, a finger grabbing slot in the rear allowing for quick removal of interchangeable messages, graphics, signs, and advertisement.

2. Said device with two connecting frames allowing anyone to insert human or computer-generated text, graphics in the message center. Interchangeability allows the removing and insertion of graphics, messages, and advertisements at will with minimum effort.

3. The device allows a vehicle owner, cars, trucks, or other, to post graphics, messages in his or her windshield, side or rear windows.

4. The device with its versatility can be used for commercial application, restaurant, where menus and other culinary advertisement can be displayed, or any related information pertaining to the establishment.

5. Said device can be used as a display tool for retail establishment, posting sales, operating time, product information or any business related information.

6. The device can be a tool for new and use auto dealers to promote, display, and post prices and vehicle specifications on the windshield, the rear and side windows.

7. The device, by means of its suction cups, will adhere to any smooth surface and allows for ease of removal and replacement.
